(19) United States
(12) Patent Application Publication
(10) Pub. No.: US 2010/0101389 A1
(43) Pub. Date: Apr. 29, 2010

(54) QUICK-RELEASE MECHANISM FOR SAW MACHINE

(75) Inventor: Cheng-Hung CHIU, Taichung (TW)

Correspondence Address: BACON & THOMAS, PLLC, 625 SLATERS LANE, FOURTH FLOOR, ALEXANDRIA, VA, 22314-1176, US

(73) Assignee: Rexon Industrial Corp., Ltd., Taichung (TW)

(21) Appl. No.: 12/604,455

(22) Filed: Oct. 23, 2009

(30) Foreign Application Priority Data
Oct. 27, 2008 (TW) 097141180

(51) Int. Cl. B27G 19/08

(52) U.S. Cl. 83/102.1; 83/701

(57) ABSTRACT

A quick-release mechanism for use in a saw machine includes a mounting member, which has a locating notch and a retaining notch, a connection member, which has a positioning surface for abutting against one side of the mounting member and a rod engageable into the locating notch, and a locking member. The locking member includes a pivot member pivotally connected to the connection member, a retaining device, and a handle operable to move the locking member relative to the connection member between a locking position, where the retaining device engages the retaining notch to lock the connection member to the mounting member, and an unlocking position, where the retaining device is disengaged from the retaining notch for enabling the rod of the connection member to be moved into and out of the locating notch.

### FIELD OF THE INVENTION

The present invention relates to wood processing machinery and more particularly, to a quick-release mechanism for use in a saw machine.

BACKGROUND

A saw machine generally has many safety devices to ensure operation safety. For example, a riving knife fixedly provided at the machine table behind the saw blade separates two cut pieces of wood, so as to eliminate kickback. Two check pawls may be respectively pivotally provided at two sides of the riving knife and configured to engage the workpiece to prohibit kickback of the cut pieces. A guard may be pivotally provided at the top side of the riving knife and extending over the top side of the saw blade to shield the top side of the saw blade.

In order to meet international safety codes, the installation and maintenance of the component parts of a saw machine are relatively complicated. To facilitate installation and maintenance, saw machine safety devices are commonly made detachable. In consequence, different quick-release mechanisms are extensively used with safety devices in saw machines.

According to the quick-release mechanisms of certain commercial saw machines, such as those described in TW M328333, TW I269680 (equivalent to U.S. Pat. No. 7,302,878), TW200823029 (equivalent to U.S. publication no. 2008/0121080) and TW M288213 (equivalent to U.S. Pat. No. 7,210,386), a lock pin is commonly used for single-point locking control. Further, according to the design shown in FIG. 1 (TW M288213), the quick-release mechanism comprises a locating hole 101 formed in a notch located on the top side of the riving knife 1. The notch has an open end and a closed end and an inner diameter of the closed end is greater than the size of the opening of the open end. A connection member 2 is located on the riving knife 1 for the pivotal connection of check pawls or a guard thereto. A pin 201 inserted through the connection member 2 has a neck 203, and a spring member 202 arranged concentrically on the pin 201 to impart a pressure to the pin 201 in order to hold the pin 201 in such a position where the neck 203 is maintained spaced from the locating hole 101 such that the pin 201 is retained in the locating hole 101, and the connection member 2 is maintained in position on the riving knife 1. This configuration of the single-point locking design of a quick-release mechanism is less stable. Further, the whole structure of the quick-release mechanism is complicated.

There are other known designs that eliminate the use of a spring means.

For example, U.S. publication no. 2008/0022826 shows a spring free design, however the design is of a single-point locking type. Further, U.S. publication no. 2008/0047409 discloses a double-point locking design. According to this design, as shown in FIG. 2, the quick-release mechanism comprises two L-shaped locating holes 301 located on the top side of a riving knife 3. A connection member 4 is pivotally connected to a guard (not shown), and two blocks 5 are fixedly provided at the bottom side of the connection member 4 for attaching to the top side of the riving knife 3. Two pins 501 are respectively mounted in the blocks 5 for being received in the L-shaped locating holes 301. A knob 6 is mounted on the connection member 4 and is rotatable to tighten the connection member 4 to the riving knife 3. According to this design, a large amount of time is required to install and uninstall the quick-release mechanism.

### SUMMARY

The present disclosure has been accomplished under the circumstances in view. Thus, embodiments of the present disclosure provide a quick-release mechanism for a saw machine, which allows quick mounting and dismounting, and assures a high level of locking safety.

To achieve this and other objects, a quick-release mechanism for use in a saw machine comprises a mounting member, a connection member, and a locking member. The mounting member has a first surface, a second surface opposite to the first surface, a top side joining one side of the first surface and one side of the second surface and extending in a first direction, a locating notch curved inwardly from the top side, and a retaining notch curved inwardly from the top side and disposed at one lateral side relative to the locating notch. The retaining notch has an opening and a positioning end spaced from and curved sideways from the opening. The connection member is selectively attachable to the mounting member in a second direction perpendicular to the first direction, and has a positioning surface for abutting against the first surface of the mounting member and a rod extending from the positioning surface and engageable with the locating notch. The locking member is adapted for locking the connection member to the mounting member, and has a pivot member pivotally connected to the connection member, a retaining device disposed at one side relative to the pivot member and engageable with the retaining notch, and a handle operable to move the retaining device relative to the connection member between a first position, where the retaining device is aligned with the opening of the retaining notch and movable into and out of the retaining notch, and a second position, where the retaining device is engaged with the positioning end to lock the connection member to the mounting member.

By means of the arrangement of the rod and the retaining device relative to the locating notch and the retaining notch, the user can operate the handle to move the retaining device into engagement with, or away from, the positioning end of the retaining notch, thus, locking or unlocking the connection member to or from the mounting member. Therefore, this quick-release mechanism has a simple structure and is easy to operate.

### BRIEF DESCRIPTION OF THE DRAWINGS

Other advantages and features of the present disclosure will be understood by reference to the following specification in conjunction with the accompanying drawings, in which like reference characters denote like elements of structure.

FIG. 1 is a schematic installed view of a quick-release mechanism according to the prior art.

FIG. 2 is a schematic installed view of another structure of a quick-release mechanism according to the prior art.

FIG. 3 is an exploded view of a quick-release mechanism in accordance with the present disclosure.

FIG. 4 is a schematic front view of the present disclosure, showing the connection member and the locking member of the quick-release mechanism attached to the mounting member.

FIG. 5 is a view similar to FIG. 4, showing the finger strip of the locking device moved from the first position to the second position and the engagement portion of the locking member moved from the unlocking position to the locking position.

FIG. 6 is a schematic drawing of the present disclosure, showing the quick-release mechanism of the present disclosure used with a saw blade guard.

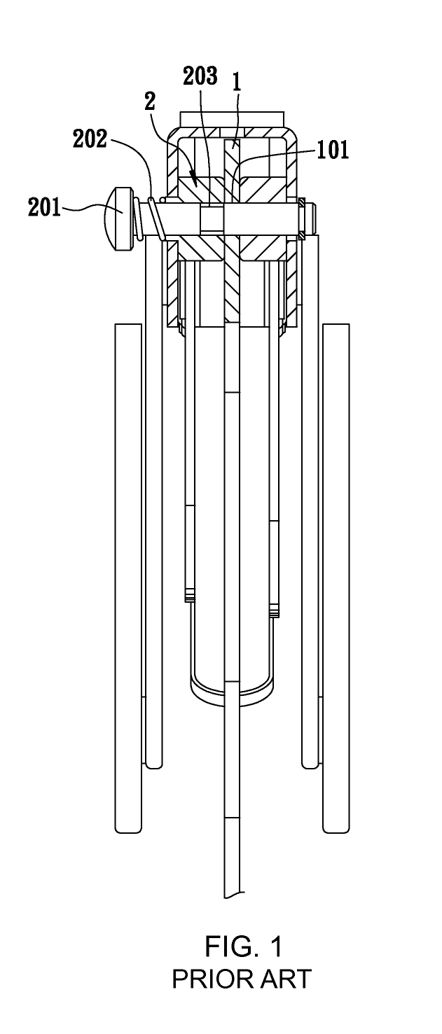

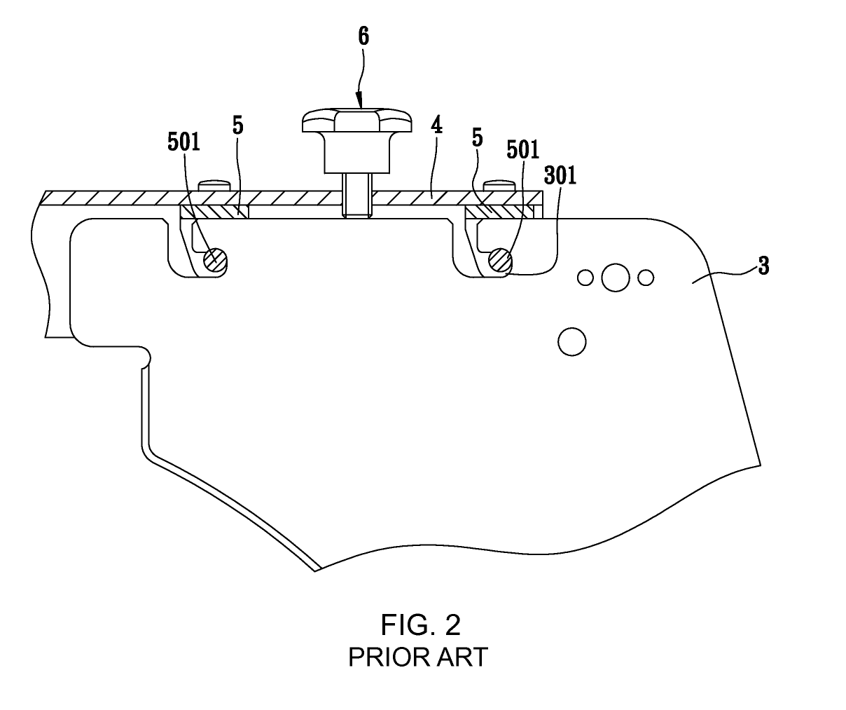

### DETAILED DESCRIPTION

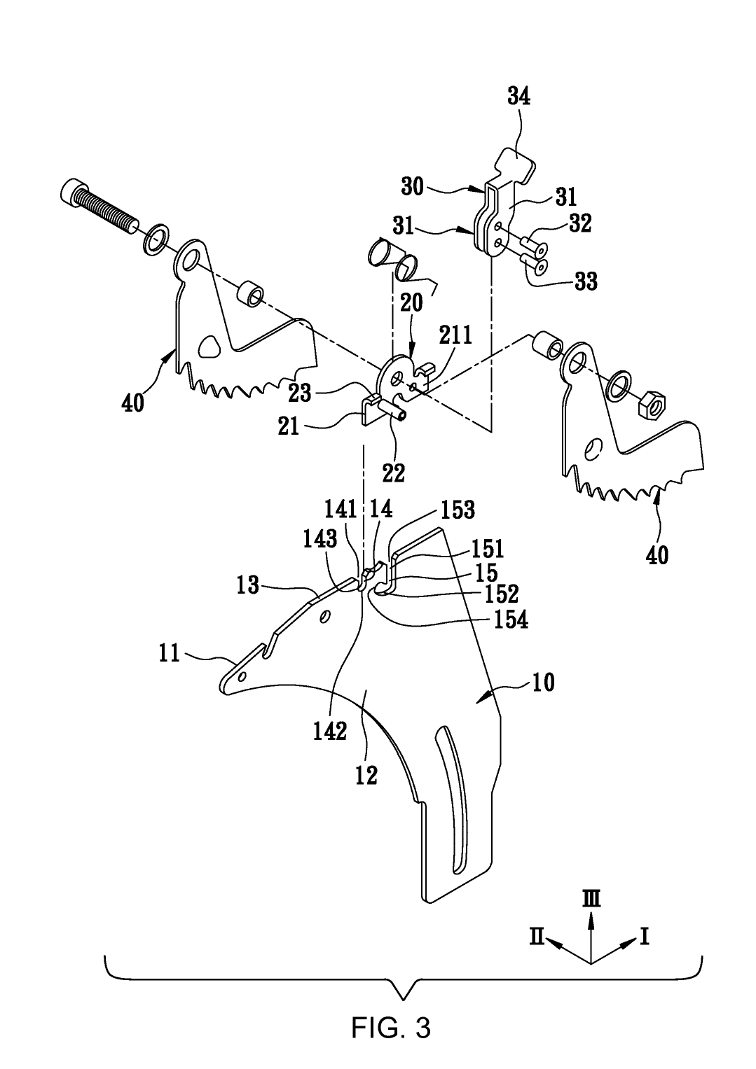

Referring to FIG. 3, a quick-release mechanism for use in a saw machine in accordance with the present disclosure is shown comprising a mounting member 10, a connection member 20, and a locking member 30 for locking the connection member 20 to the mounting member 10. According to this embodiment, the mounting member 10 is a riving knife. The connection member 20 is adapted for the pivotal connection of two check pawls 40 at two sides relative to the mounting member 10.

The mounting member 10 is a thin flat plate member having a first surface 11, a second surface 12 opposite to the first surface 11. A top side 13 joins the topmost edge of the first surface 11 and the topmost edge of the second surface 12 and extending in a first direction I. A locating notch 14 is curved inwardly from the top side 13 and a retaining notch 15 is curved inwardly from the top side 13 and is disposed at one lateral side relative to the locating notch 14. The locating notch 14 and the retaining notch 15 extend through the first surface 11 and the second surface 12 in a second direction II perpendicular to the first direction I. The locating notch 14 and the retaining notch 15 each have a single open end configuration. The locating notch 14 has an opening 141 formed at the top side 13 of the mounting member 10, a bottom edge 142 extending downwardly from the opening 141 in a third direction III perpendicular to the first direction I and the second direction II, and a positioning portion 143 located on the bottom edge 142 at one lateral side relative to the opening 141. The retaining notch 15 has a straight open segment 151 extending downwardly from the top side 13 in the third direction III, and a smooth arcuate retaining segment 152 extending from the inner end of the straight segment 151. The straight segment 151 has its outer end terminating in an opening 153 at the top side 13, and its inner end terminating in the retaining segment 152. The retaining segment 152 extends sideways from the inner end of the straight segment 151 toward the locating notch 14 and terminates in a positioning end 154.

The connection member 20 is selectively attachable to the mounting member 10 in the third direction III, and includes a flat base 21, a rod 22 extending along the second direction II from the base 21, and two hooks 23 bilaterally extending from a top side of the base 21. The base 21 has a positioning surface 211 for abutting against the first surface 11 of the mounting member 10. The hooks 23 are adapted for being selectively hooked onto the top side 13 of the mounting member 10.

The locking member 30 is defined by two parallel flat arms 31. A pivot member 32 is affixed to the flat arms 31, and a retaining device 33 is disposed adjacent to the pivot 32 for engaging the retaining notch 15. A handle 34 is operable to move the retaining device 33 relative to the flat base 21 of the connection member 20. The pivot member 32 is a pin connected between the flat arms 31 and is pivotally mounted on the flat base 21 of the connection member 20. The retaining device 33 is a pin inserted through the flat arms 31 at one end thereof. The handle 34 is connected to the flat arms 31 at the other end thereof.

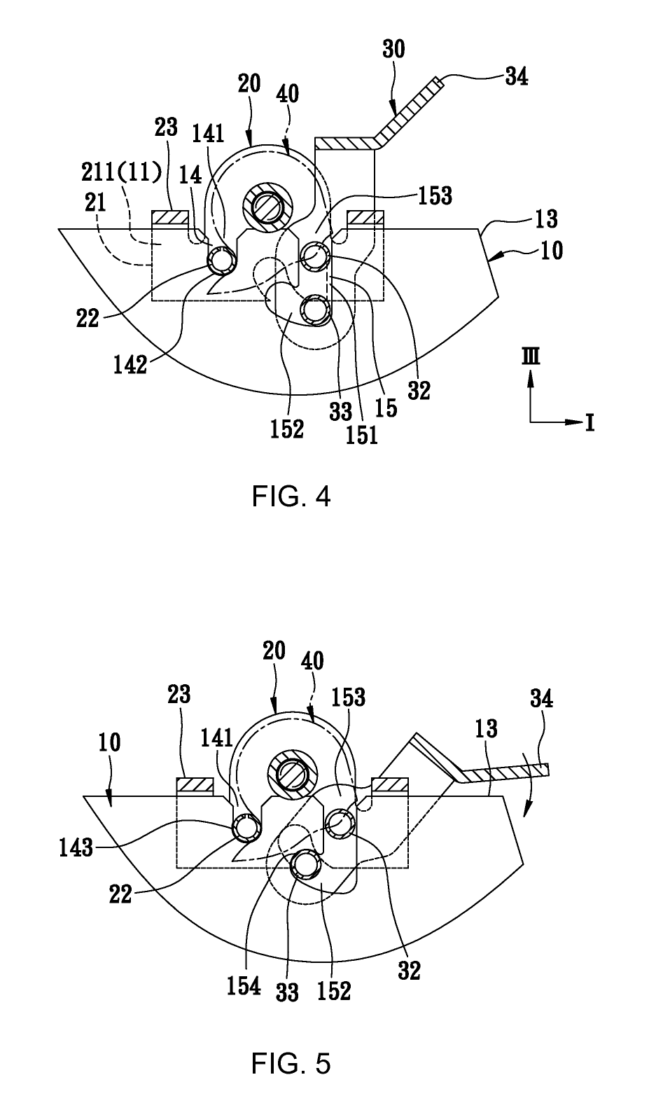

Referring to FIGS. 3 and 4, during installation of the connection member 20 onto the mounting member 10, the locking member 30 is manipulated to align the retaining device 33 with the retaining notch 15, and then the connection member 20 is moved in the third direction III toward the mounting member 10 to abut the positioning surface 211 of the connection member 20 against the first surface 11 of the mounting member 10. In this manner, the rod 22 passes through the opening 141 into the inside of the locating notch 14 and the retaining device 33 passes through the opening 153 into the retaining notch 15. At this time, the hooks 23 are respectively attached to the top side 13 of the mounting member 10, the rod 22 touches the bottom edge 142, and the retaining device 33 reaches the connection area between the straight segment 151 and the retaining segment 152 (the handle 34 is in a first position spaced away from the top side 13 of the mounting member 10).

Referring to FIG. 5, when the user moves the handle 34 from the first position to a second position adjacent to the top side 13 of the mounting member 10, the retaining device 33 is rotated about the axis extending through the pivot member 32 along the retaining segment 152 from an unlocking position, facing to the opening 153, to a locking position, where the retaining device 33 is moved into engagement with the positioning end 154 and the rod 22 engages the positioning portion 143. At this time, the retaining device 33 and the rod 22 are prevented from accidental removal out of the opening 153 and the opening 141 in the third direction III, and the connection member 20 is thus locked to the mounting member 10.

To dismount the quick-release mechanism, the handle 34 is moved from the second position to the first position (from the status shown FIG. 5 to the status shown in FIG. 4) in order to move the retaining device 33 from the locking position, where the retaining device 33 is in engagement with the positioning end 154, to the unlocking position where the retaining device 33 is maintained in alignment with the opening 153. At this time, the user can lift the connection member 20 and the locking member 30 from the mounting member 10 to separate the retaining device 33 and the rod 22 from the retaining notch 15 and the locating notch 14. Thus, mounting and dismounting operations of the quick-release mechanism according to the present disclosure are quite simple.

Therefore, the quick-release mechanism of the present disclosure has the characteristics of simple structure, ease of fabrication, and ease of mounting and dismounting. By means of attaching the rod 22 and the retaining device 33 into the locating notch 14 and the retaining notch 15 and then moving the handle 34 to engage the retaining device 33 with the positioning end 154, a two-point locating function is achieved. Further, the rod 22 and the retaining device 33 can be moved into or away from the locating notch 14 and the retaining notch 15 directly without any additional procedures.

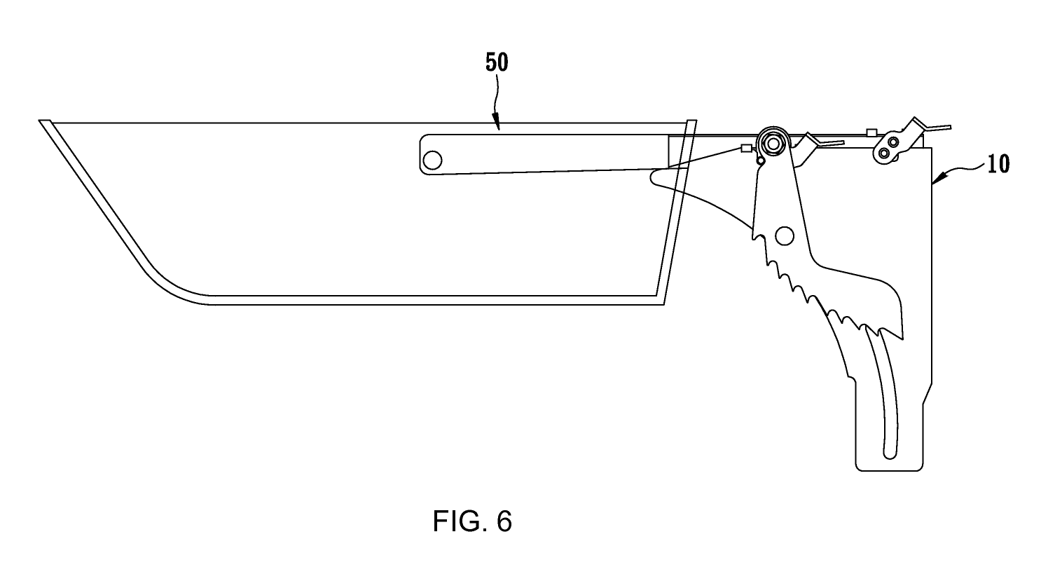

Referring to FIG. 6, the quick-release mechanism can also be used to lock a saw blade guard 50 to the mounting member 10 (riving knife).

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A quick-release mechanism for use in a saw machine, comprising:
a mounting member having a first surface, a second surface opposite to said first surface, a top side joining one side of said first surface and one side of said second surface and extending in a first direction, a locating notch curved inwardly from said top side, and a retaining notch curved inwardly from said top side and disposed at one lateral side relative to said locating notch, said retaining notch having an opening and a positioning end curved sideways away from said opening;
a connection member selectively attached to said mounting member in a second direction perpendicular to said first direction, said connection member having a positioning surface for abutting against said first surface of said mounting member and a rod extending from said positioning surface and selectively engaged with said locating notch; and
a locking member for locking said connection member to said mounting member, said locking member having a pivot member pivotally connected to said connection member, a retaining device disposed at one side relative to said pivot member and selectively engaged with said retaining notch, and a handle operable to move said retaining device relative to said connection member between a first position, whereat said retaining device is aligned with said opening of said retaining notch and movable into and out of said retaining notch, and a second position, whereat said retaining device is engaged with said positioning end to lock said connection member to said mounting member.

2. The quick-release mechanism as claimed in claim 1, wherein said locking member has two parallel flat arms; said pivot member is a pivot pin pivotally inserted through said connection member and connected between said two flat arms; said retaining device is a pin fastened to one end of each of said two flat arms remotely from said handle.

3. The quick-release mechanism as claimed in claim 1, wherein said locking notch has an opening formed on said top side of said mounting member, a bottom edge opposite to said opening of said locating notch, and a positioning portion located on said bottom edge at one lateral side relative to said opening of said locating notch; and said retaining notch has a straight open segment extending in a third direction perpendicular to said first direction and said second direction, and a retaining segment, said straight open segment having an outer end terminating in said opening of said retaining notch and an inner end terminating in said retaining segment, and said retaining segment is arcuate and extended sideways from said inner end of said straight segment toward said locating notch and terminating in said positioning end.

4. The quick-release mechanism as claimed in claim 1, wherein said connection member has a flat base carrying said positioning surface, and two hooks extend bilaterally from a top side of said flat base and selectively engage said top side of said mounting member.

5. The quick-release mechanism as claimed in claim 1, wherein said mounting member is a riving knife.
